(19) United States
(12) Patent Application Publication
(10) Pub. No.: US 2009/0312985 A1
(43) Pub. Date: Dec. 17, 2009

(54) Multiple hypothesis tracking

(76) Inventor: Austin I.D. Eliazar, Morrisville, NC (US)

Correspondence Address: John L. Sotomayor, 106 Spring Needle Ct., Cary, NC, 27513, US

(21) Appl. No.: 12/157,703

(22) Filed: Jun. 12, 2008

(51) Int. Cl. G06F 15/00

(52) U.S. Cl. 702/187; 702/189

(57) ABSTRACT

Multiple hypothesis tracking is a system which enables an analytic sensor framework to capture sensor data and simultaneously account for many possible instantiations of objects, trajectories and behaviors that may be represented within the captured data. Each data instantiation is represented by a different likelihood of possibility based upon data used to train the recognition module of the analytic sensor framework and/or prior knowledge of an analyst. The data instantiations for objects, trajectories, and behaviors are identified in real time.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND OF THE INVENTION

The present invention is directed toward novel means and methods for analyzing data captured from various sensor suites and systems and retaining this captured data for retroactive tracking activity. The sensor suites and systems used with the present invention may consist of video, audio, radar, infrared, or any other sensor suite for which data can be extracted, collected and presented to users.

Most video analytic approaches in common use force a maximum likelihood fit to the data after each frame has been analyzed and purge all remaining data and evidence. A problem occurs if a probabilistic approach determines that in a data frame an object being tracked is nearly equally likely to be following one of several tracks. A system using a traditional approach picks one track, or abandons the current data in favor of the next frame of data hoping that the next frame of data will be more informative. There is a need for retention of information in multiple frames, calculating multiple possible tracks and utilizing all available data in an informative way. A need exists to provide better event detection performance within the captured data with fewer false alarms as well as maintaining a trace record of data item occurrences through multiple data capture actions.

### BRIEF DESCRIPTION OF THE DRAWINGS

FIG. 1: a multiple hypothesis tracking process flow consistent with certain embodiments of the invention.

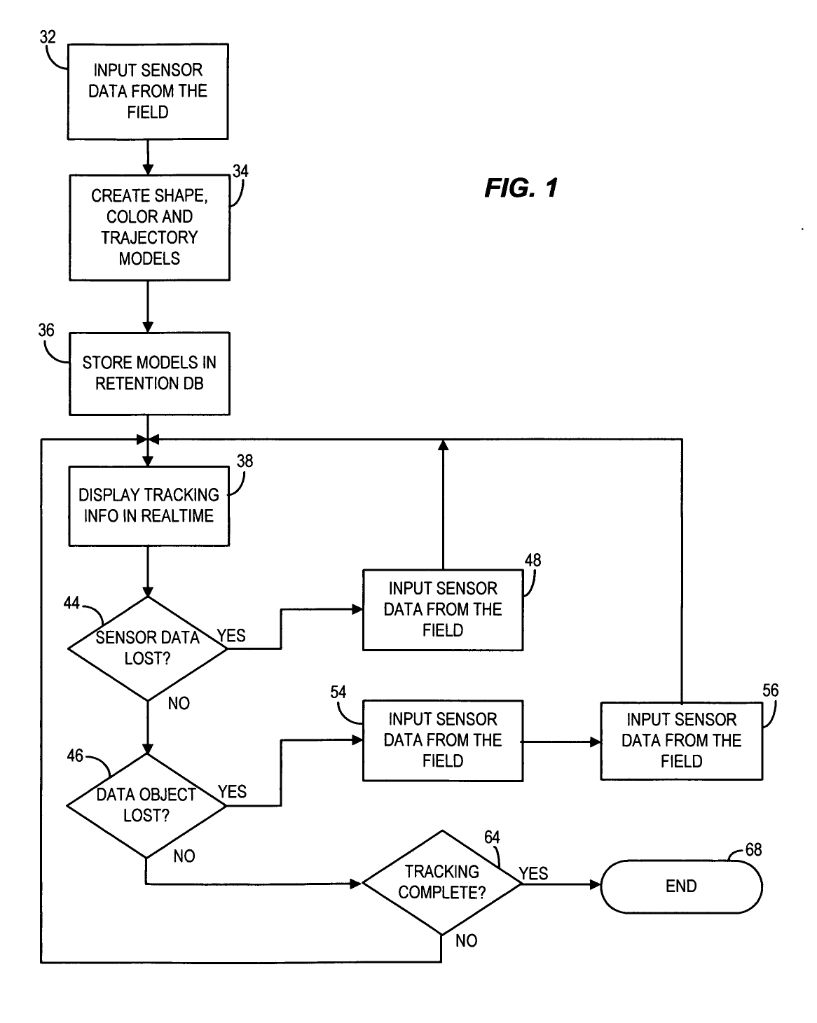

FIG. 2: a system diagram for the Active Multi-Sensor System design consistent with certain embodiments of the invention.

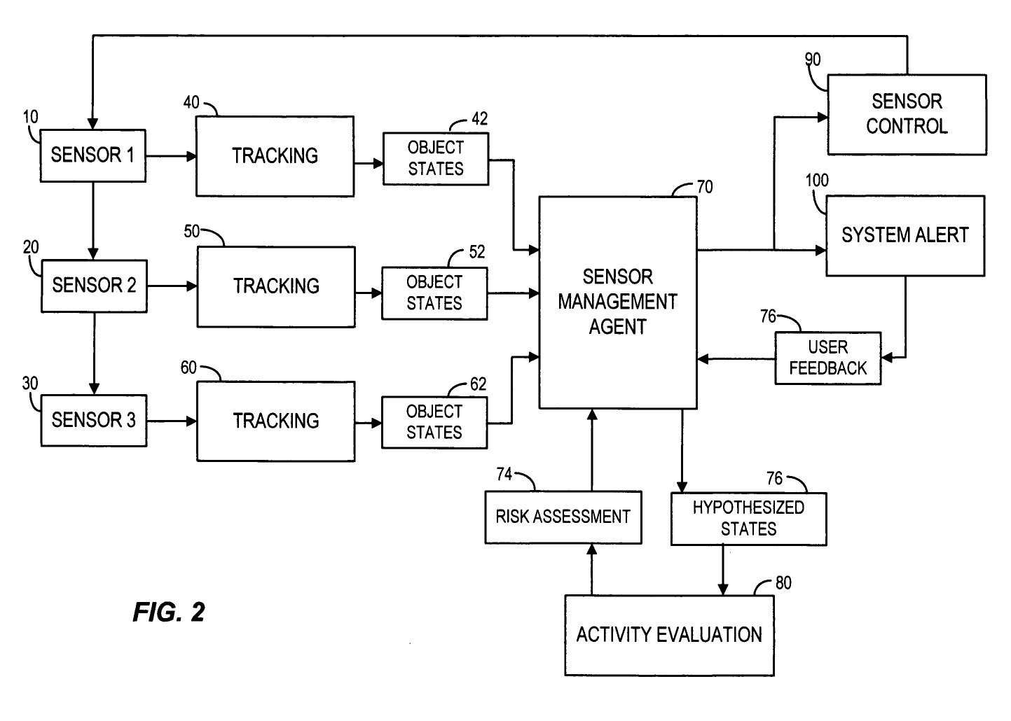

FIG. 3: detailed system diagram for the Tracking module of the Active Multi-Sensor System consistent with certain embodiments of the invention.

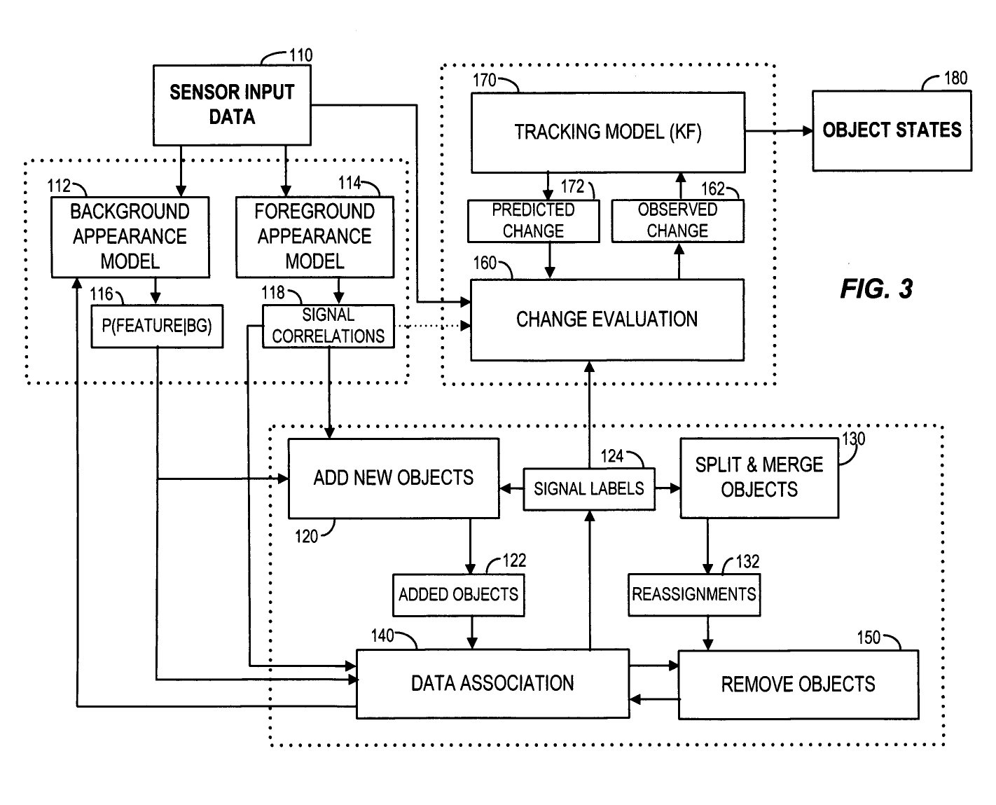

FIG. 4: detailed system diagram for the Sensor Management Agent of the Active Multi-Sensor System consistent with certain embodiments of the invention.

FIG. 5: detailed system diagram for the Activity Evaluation module of the Active Multi-Sensor System consistent with certain embodiments of the invention.

### DETAILED DESCRIPTION OF THE INVENTION

The pages that follow describe experimental work, presentations and progress reports that disclose currently preferred embodiments consistent with the above-entitled invention. All of these documents form a part of this disclosure and are fully incorporated by reference. This description incorporates many details and specifications that are not intended to limit the scope of protection of any utility patent application which might be filed in the future based upon this provisional application. Rather, it is intended to describe an illustrative example with specific requirements associated with that example. The description that follows should, therefore, only be considered as exemplary of the many possible embodiments and broad scope of the present invention. Those skilled in the art will appreciate the many advantages and variations possible on consideration of the following description.

Thus, the reader should understand that the present document, while describing commercial embodiments, should not be considered limiting since many variations of the inventions disclosed herein will be come evident in light of this discussion. While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described.

Multiple Hypothesis Tracking is a ground-breaking concept which enables an analytic sensor framework to capture sensor data and simultaneously account for many possible instantiations of objects, trajectories and behaviors that may be represented within the captured data. Each data instantiation is represented by a different likelihood of possibility based upon data used to train the recognition module of the analytic sensor framework and/or prior knowledge of an analyst. The data instantiations for objects, trajectories, and behaviors are identified in real time.

The Multiple Hypothesis Tracking system maintains captured data regarding color, shape, and trajectory for data sets that are used for tracking objects. The color model utilizes a set of basis vectors within RGB (Red-Green-Blue) color space which are able to almost completely eliminate any covariant terms between the basis vectors, allowing each component color data to be treated as independent. Under this new formulation of color data, significantly fewer Gaussian components are necessary to correctly model the background color behavior of the captured data, often no more than one. These methods for learning the variance on color models are much more accurate in their depiction of the color values of the captured data.

The instant invention was created to address the real-world need for predictive analysis in systems that determine policies for alerts and action so as to manage or prevent anomalous actions or activities and to recursively track and maintain changes in captured data sets. The predictive nature of the instant invention is built around the capture of data from any of a plurality of sensor suites (10-30) coupled with an analysis of the captured data using statistical modeling tools. The system also employs a relational learning method 160, system feedback (either automated or human directed) 76, and a cost comprised of a weighting of risk associated with the likelihood of any predicted action 74. Once anomalous behavior has been detected, the instant invention, with or without a user contribution 76, can formulate policies and direct actions in a monitored area 260.

The preferred embodiment presented in this disclosure uses a suite of audio and video sensors (10-30) to capture and analyze audio/visual imagery. However, this in no way limits the instant invention to just this set of sensors or captured data. The invention may be used with any type of sensor or any suite of deployed sensors with equal facility.

Captured input data is routed from the sensors (10-30) to a series of tacking software modules (40-60) which are operative to incorporate incoming data into a series of object states (42-62). The Sensor Management Agent (SMA) 70 uses the input object states (42-62) data to produce an estimate of change for the state data. These hypothesized states 72 data are presented as input to the Activity Evaluation module 80. The Activity Evaluation module produces a risk assessment 74 evaluation for each input object state and provides this information to the SMA 70. The SMA determines whether the risk assessment 74 data exceeds an information threshold and issues system alerts 100 based upon the result. The SMA also provides next measurement operational information to the sensors (10-30) through the Sensor Control module 90. The system is also operative to provide User feedback 76 as an additional input to the SMA 70.

In the preferred embodiment, several feature-extraction techniques have been considered, and the statistical variability of such has been analyzed using hidden Markov models (HMMs) as the statistical modeling method of choice. Other statistical modeling methods may be used with equal facility. The inventors chose HMMs for their familiarity with the modeling method involved. In addition, entropic information-theoretic metrics have been employed to quantify the variability in the associated underlying data.

In the preferred embodiment, challenge for anomalous event detection in video data is to first separate foreground object activity 114 from the background scene 112. The inventors investigated using an inter-frame difference approach that yields high intensity pixel values in the vicinity of dynamic object motion. While the inter-frame difference is computationally efficient, it is ineffective at highlighting objects that are temporarily at rest and is highly sensitive to natural background motion not related to activity of interest such as tree and leaf motion. The inventive system currently employs a statistical background model using principal components analysis (PCA), with the background eigen-image corresponding to the principal image component with the largest eigenvalue. The PCA is performed on data acquired at regular intervals (e.g. every five minutes) such that environmental conditions (e.g. angle of illumination) are adaptively incorporated into the background model 112. Objects within a scene that are not part of the PCA background can easily be computed via projection onto the orthogonal subspace. An alternate embodiment of the inventive system may use nonlinear object ID and tracking methods.

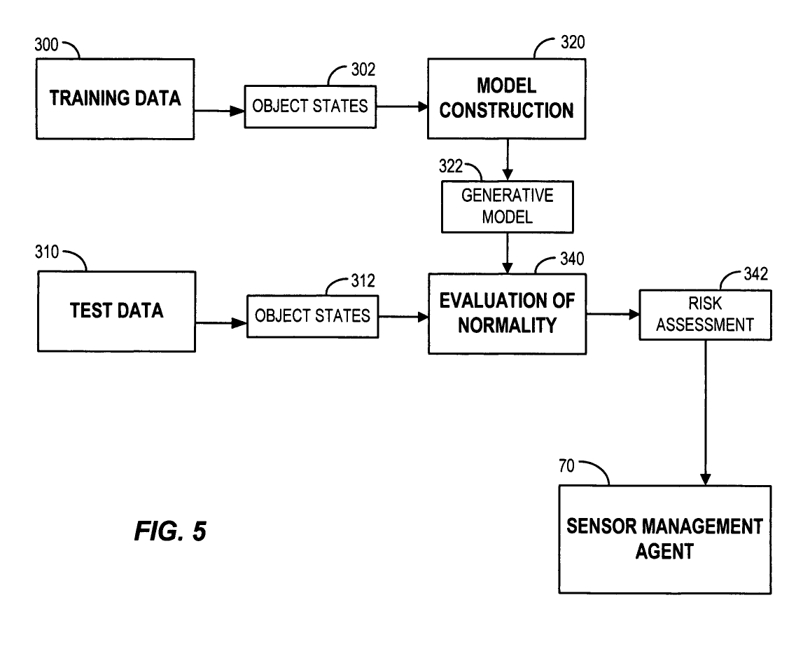

The objects within a scene are characterized via a feature-based representation of each object. The preferred embodiment uses a parametric representation of the distance between the object centroid and the external object boundary as a function of angle (FIG. 5). One of the strengths of this approach to object feature representation is the invariance to object-camera distance and the flexibility to describe multiple types of objects (people, vehicles, people on horses, etc.). This process produces a model of dynamic feature behavior that may be used to detect features and maintain an informational flow about said features that provide continuous mapping of artifacts and features identified by the system. This map results in a functional description of a dynamic object, which, in the preferred embodiment, may then be used as in input to a statistical modeling algorithm.

An objective in the preferred embodiment is to track level-set-derived target silhouettes through occlusions, caused by moving objects going through one another in the video. A particle filter is used to estimate the conditional probability distribution of the contour of the objects at time τ, conditioned on observations up to time τ. The video/data evolution time τ should be contrasted with the time-evolution t of the level-sets, the later yielding the target silhouette (FIG. 5).

The idea is to represent the posterior density function by a set of random samples with associated weights, and to compute estimates based on these samples and weights. Particle filtering approximates the density function as a finite set of samples. The inventors first review basic concepts from the theory of particle filtering, including the general prediction-update framework that it is based on, and then we describe the algorithm used for tracking objects during occlusions.

Let X_{τ}ε [symbol] ⁿ be a state vector at time τ evolving according to the following difference equation

X_{τ+1}=f_{τ}(X_{τ})+u_{τ} (1)

where u_{τ} is i.i.d. random noise with known probability distribution function p_{u,τ}. Here the state vector describes the time-evolving data. At discrete times the observation Y_{τ}ε [symbol] ^{p} is available and our objective is to provide a density function for X_{τ}. The measurements are related to the state vector via the observation equation

Y_{τ}=h_{τ}(X_{τ})+v_{τ} (2)

where v_{τ} is measurement noise with known probability density function p_{v,τ} and h_{τ} is the observation function.

The silhouette resulting from the level-sets analysis is used as the state, and the image at time τ as the observation, i.e. Y_{τ}=I_{τ}(x,y). It is assumed that the system knows the initial state distribution denoted by p(X₀)=p₀(dx), the state transition probability p(X_{τ}|X_{τ-1}) and the observation likelihood given the state, denoted by g_{τ}(Y_{τ}|X_{τ}). The particle filter algorithm used in the preferred embodiment is based on a general prediction-update framework which consists of the following two steps:
Prediction step: Using the Chapman-Kolmogoroff equation, compute the prior state X_{τ}, without knowledge of the measurement at time τ, Y_{τ}

p(X_{τ}|Y_{0:τ-1})=∫p(X_{τ}|X_{τ-1})p(X_{τ-1}|Y_{0:τ-1})dx_{τ-1} (3)
Update step: Compute the posterior probability density function p(X_{τ}|Y_{0:τ}) from the predicted prior p(X_{τ}|Y_{0:τ-1}) and the new measurement at time τ, Y_{τ}

$$p ( {X}_{τ} \vert {Y}_{0 : τ} ) = \frac{p ( {Y}_{τ} \vert {X}_{τ} ) p ( {X}_{τ} \vert {Y}_{0 : τ - 1} )}{p ( {Y}_{τ} \vert {Y}_{0 : τ - 1} )} \qquad ( 4 )$$

where

p(Y_{τ}|Y_{0:τ-1})=∫p(Y_{τ}|X_{τ})p(X_{τ}|Y_{0:τ-1})dx_{τ} (5)

Since it is currently impractical to solve the integrals analytically, the system represents the posterior probabilities by a set of randomly chosen weighted samples (particles).

The particle filtering framework used in the preferred embodiment is a sequential Monte Carlo method which produces at each time τ, a cloud of N particles, {X_{τ}⁽ⁱ⁾}ᵢ₌₁^{N}. This empirical measure closely “follows” p(X_{τ}|Y_{0:τ}), the posterior distribution of the state given past observations (denoted by p_{τ|τ}(dx) below).

The initial step of the algorithm is to sample N times from the initial state distribution p₀(dx), using the principle of importance sampling, to approximate it by

$${p}_{0}^{N} ( dx ) = \frac{1}{N} {\sum }_{i = 1}^{N} {δ}_{{X}_{0}^{( i )}} ( dx ) ,$$

and then implement the Bayes' recursion at each time step (FIG. 6).
Now, the distribution of X_{τ-1} given observations up to time τ−1 can be approximated by

$${p}_{t - 1 \vert τ - 1}^{N} ( dx ) = \frac{1}{N} {\sum }_{i = 1}^{N} {δ}_{{X}_{τ - 1}^{( i )}} ( dx ) \qquad ( 6 )$$

The algorithm used for tracking objects during occlusions consists of a particle filtering framework that uses level-sets results for each update step.

This technique will allow the inventive system to track moving people during occlusions. In occlusion scenarios, using just the level sets algorithm would fail to detect the boundaries of the moving objects. Using particle filtering, we get an estimate of the state for the next moment in time p(X_{τ}|Y_{1:τ-1}), update the state

$$p ( {X}_{τ} \vert {Y}_{1 : τ} ) \approx {\sum }_{i = 1}^{N} \frac{1}{N} {δ}_{{X}_{τ}^{( i )}} ( dx ) ,$$

and then use level sets for only a few iterations, to update the image contour γ(τ+1). With this algorithm, objects are tracked through occlusions and the system is capable of approximating the silhouette of the occluded objects.

The hidden Markov model (HMM) is a popular statistical tool for modeling a wide range of time series data. The HMM represents one special case of more-general graphical models and was chosen for use in the preferred embodiment for its ability to model time series data and the time-evolving properties of the object features.

Temporal object dynamics are represented via a HMM, with multiple HMMs developed to represent canonical “normal” object behavior. The underlying HMM states serve to capture the variety of object feature manifestations that may be observed for normal behavior. For example, as a person walks, the object features typically exhibit a periodicity that can be captured by an appropriate HMM state-transition architecture. In the preferred embodiment, the object features are represented using a discrete HMM with a regularization term to mitigate association of anomalous features to the discrete feature codebook developed while training the system 320. Variational Bayes methods are used to determine the proper number of HMM states 220. Such methods may also be applied to determining the optimal number of codebook elements for each state, or the optimal number of mixture components if a continuous Gaussian mixture model representation (GMM) is utilized.

The instant invention defines the “state” of a moving target by its orientation with respect to the sensor (e.g., video camera). For example, in the preferred embodiment a car or individual may have three principal states, defined by the view of the target from the sensor: (i) front view, (ii) back view and (iii) side view. This is a general concept, and the number of appropriate states will be determined from the data, using Bayesian model selection.

In general the sensor has access to the data for a given target, while the explicit state of the target with respect to the sensor is typically unknown, or “hidden”. The target generally will move in a predictable fashion, with for example a front view followed by a side view, with this followed by a rear view. However, there is some non-zero probability that this sequence may be altered slightly for a specific target. The instant invention has developed an underlying Markovian model for the sequential motion of the target. Specifically, the probability that the target will be in a given state at time index n is dictated completely by the state in which the target resides at time index n−1. Since the underlying target motion is modeled via a Markov model in the preferred embodiment, and the underlying state sequence is “hidden”, this yields a hidden Markov model (HMM).

The HMM is defined by four principal quantities: (i) the set of states S; (ii) the probability of transitioning from state i to state j on consecutive observations, represented by p(sⱼ|sᵢ); (iii) the probability of being in state i for the initial observation, this represented by πᵢ; and (iv) the probability of observing data o in state s, represented as p(o|s). For a Partially Observed Markov Decision Policy (POMDP) this model is generalized to take into account the effects of the sensing action a, represented by p(o|s,a) and p(sⱼ|sᵢ,a).

There are standard algorithms for learning the model parameters if the number of states S is known a priori. For example, one may utilize the Baum-Welch or Viterbi algorithm for HMM parameter design. However, for the adaptive learning algorithms of the preferred embodiment, the number of states may not be known a priori, and this must be determined based on the data. For example, different types of targets (individuals, vehicles, small groups, etc.) may have different numbers of states, and this must be determined autonomously by the algorithm.

In the preferred embodiment the system employs the variational Bayes method, in which the prior p(θ|Hᵢ) is assumed separable in each of the parameters,

$$p ( θ \vert {H}_{i} ) = {\prod }_{m = 1}^{M} p ( {θ}_{m} \vert {H}_{i} ) ,$$

and each of the p(θₘ|Hᵢ) is made conjugate to the corresponding component within the likelihood p(D|θ,Hᵢ). Because of the assumed conjugate priors, the posterior may also be approximated as a product of the same conjugate density functions, which we employ as a basis for the posterior. In particular, let

Q(θ;β)≈p(θ|D,Hᵢ) (9)

be a parametric approximation to the posterior, with the parameters β defined by the parameters of the corresponding conjugate basis functions. The variational functional F(β) is defined as

$$\begin{matrix}\begin{matrix}F ( β ) = \int d θ Q ( θ ; β ) ln \frac{Q ( θ ; β )}{p ( D \vert θ , {H}_{i} ) p ( θ \vert {H}_{i} )} \\ = {D}_{KL} [ Q ( θ ; β ) \vert \vert p ( θ \vert D , {H}_{i} ) ] - ln p ( D \vert {H}_{i} )\end{matrix} & ( 10 )\end{matrix}$$

By examining the right hand side of (10), we note that F(θ) is lower bounded by ln p(D|Hᵢ), with the lower bound achieved with the Kullback-Leibler distance between the basis Q(θ;β) and the posterior p(θ|D,Hᵢ), D_{KL}[Q(θ;β)∥p(θ|D,Hᵢ)], is minimized. Given the conjugate form of the basis in (9), the integrals in (10) may often be computed analytically, for many graphical models, and specifically for the HMM. The variational Bayes algorithm consists of iteratively determining the basis-function parameters β that minimize (10), and the minimal F(β) so determined is an approximation to ln p(D|Hᵢ). This provides the log evidence for model Hᵢ, allowing the desired model comparison.

This therefore constitutes an autonomous sensor-management framework for adaptive multi-sensor sensing of atypical behavior in the Tracking module 170 of the instant invention.

The generative statistical models (HMMs) summarized above will be utilized in the preferred embodiment to provide sensor exploitation by an adaptive learning system module 240 within the Sensor Management Agent (SMA) 70. This is implemented by employing feedback between the observed data and sensor parameters (optimal adaptive sensor management) (FIG. 6). In particular, the preferred embodiment utilizes POMDP generative models of the type discussed above to constitute optimal policies for modifying sensor parameters based on observed data. Specifically, the POMDP is defined by a set of states, actions, observations and rewards (costs). Given a sequence of n actions and observations, respectively {a₁, a₂, . . . , aₙ} and {o₁, o₂, . . . , oₙ}, the statistical models yield a belief bₙ concerning the state of the environment under surveillance. The POMDP yields an optimal policy for mapping the belief state after n measurements into the optimal next action: bₙ→aₙ₊₁. This policy is based on a finite or infinite horizon of measurements and it accounts for the cost of implementing the measurements defined, for example, in units of time, as well as the Bayes risk associated with making decisions about the state of the environment (normal vs. anomalous behavior).

The POMDP framework is a mathematically rigorous means of addressing observed multi-sensor imagery (defining the observations o), different deployments of sensor parameters (defining the actions a), as well as the costs of sensing and of making decision errors. While learning of the policy is computationally challenging, this is a one-time “off-line” computation, and the execution of the learned policy may be implemented in real time (it is a look-up table that implements the mapping bₙ→aₙ₊₁). This framework provides a natural means of providing feedback between the observed data to the sensors, to optimize multi-sensor networks. The preferred embodiment will focus on multiple camera sensors. However, the general framework is applicable to any multi-sensor system that can employ feedback to optimize sensor management.

The partially observable Markov decision process (POMDP) represents the heart of the proposed algorithmic developments. The POMDP use in the preferred embodiment represents a significant new advancement for optimizing sensor management.

Partially observable Markov decision processes (POMDPs) are well suited to non-myopic sensing problems, which are those problems in which a policy is based on a finite or infinite horizon of measurements. It has been demonstrated previously that sensing a target from multiple target-sensor orientations may be modeled via a hidden Markov model (HMM). In the preferred embodiment, this concept may be extended to general sensor modalities and moving targets, as in video. Each state of the HMM corresponds to a contiguous set of target-sensor orientations for which the observed data are relatively stationary. When the sensor interrogates a given target (person/vehicle, or multiple people/vehicles) from a sequence of target-sensor orientations, it inherently samples different target states (FIG. 7). The instant invention extends the HMM formalism to a POMDP, yielding a natural and flexible adaptive-sensing framework for use within the Sensor Management Agent 70.

The POMDP is formulated in terms of Bayes risk, with Cᵤᵥ representing the cost of declaring target u when actually the target under interrogation is target v. Using the same units as associated with Cᵤᵥ, the instant invention also defines a cost for each class of sensing action. The use of Bayes risk allows a natural means of addressing the asymmetric threat, through asymmetry in the costs Cᵤᵥ. After a set of sensing actions and observations the sensor may utilize the belief state to quantify the probability that the target under interrogation corresponds to target u. The POMDP yields a non-myopic policy for the optimal sensor action given the belief state, where here the sensor actions correspond to defining the next sensor to deploy, as well as the associated sensor resolution (e.g., use of zoom in video). In addition, the POMDP gives a policy for when the belief state indicates that sufficient sensing has been undertaken on a given target to make a decision as to whether it is typical/atypical.

The instant invention computes the belief state and Bayes risk for data captured by the sensor suite. After performing a sequence of T actions and making T observations, we may compute the belief state for any state sεS={sₖ⁽ⁿ⁾,∀k,n} as

b_{T}(s|o₁, . . . , o_{T},a₁, . . . , a_{T})=Pr(s|o_{T},a_{T},b_{T-1}) (11)

where (11) reflects that the belief state b_{T-1} is a sufficient statistic for {a₁, . . . , a_{T-1}, o₁, . . . , o_{T-1}}. Note that the belief state is defined across the states from all targets, and it may be computed via

$$\begin{matrix}\begin{matrix}{b}_{T} ( {s}^{′} ) = \frac{Pr ( {o}_{T} \vert {s}^{′} , {a}_{T} , {b}_{T - 1} ) Pr ( {s}^{′} \vert {a}_{T} , {b}_{T - 1} )}{Pr ( {o}_{T} \vert {a}_{T} , {b}_{T - 1} )} \\ = \frac{\begin{matrix}Pr ( {o}_{T} \vert {s}^{′} , {a}_{T} , {b}_{T - 1} ) {\sum }_{s} \\ Pr ( {s}^{′} \vert {a}_{T} , {b}_{T - 1} , s ) Pr ( s \vert {a}_{T} , {b}_{T - 1} )\end{matrix}}{Pr ( {o}_{T} \vert {a}_{T} , {b}_{T - 1} )} \\ = \frac{p ( {o}_{T} \vert {s}^{′} , {a}_{T} ) {\sum }_{s} p ( {s}^{′} \vert {a}_{T} , s ) {b}_{T - 1} ( s )}{Pr ( {o}_{T} \vert {a}_{T} , {b}_{T - 1} )}\end{matrix} & ( 12 )\end{matrix}$$

The denominator Pr(o_{T}|a,b_{T-1}) may be viewed as a normalization constant, independent of s′, allowing b_{T}(s′) to sum to one.

After T actions and observations we may use (12) to compute the probability that a given state, across all N targets, is being observed. The belief state in (12) may also be used to compute the probability that target class n is being interrogated, with the result

$$p ( n \vert {o}_{1} , … , {o}_{T} , {a}_{1} , … , {a}_{T} ) = p ( n \vert {b}_{T} ) = {\sum }_{s ∈ {S}_{n}} {b}_{T} ( s ) \qquad ( 13 )$$

where Sₙ denotes the set of states associated with target n.

The SMA defines Cᵤᵥ to denote the cost of declaring the object under interrogation to be target u, when in reality it is target v, where u and v are members of the set {1, 2, . . . , N}, defining the N targets of interest. After T actions and observations, target classification may be effected by minimizing the Bayes risk, i.e., we declare the target

$$Target = {arg min}_{u} {\sum }_{v = 1}^{N} {C}_{uv} p ( v \vert {b}_{T} ) = {arg min}_{u} {\sum }_{v = 1}^{N} {C}_{uv} {\sum }_{e ∈ {S}_{v}} {b}_{T} ( s ) \qquad ( 14 )$$

Therefore, a classification may be performed at any point in the sensing process using the belief state b_{T}(s).

The instant invention also calculates a cost associated with deploying sensors and collecting data from said sensors. The sensing actions are defined by the cost of deploying the associated sensor. With regard to the terminal classification action, there are N² terminal states that may be visited. Terminal state sᵤᵥ is defined by taking the action of declaring that the object under interrogation is target u when in reality it is target v; the cost of state sᵤᵥ is Cᵤᵥ, as defined in the context of the Bayes risk previously calculated. The sensing costs and Bayes-risk costs must be in the same units. Making the above discussion quantitative, c(s,a) represents the immediate cost of performing action a when in state s. For the sensing actions indicated above c(s,a) is independent of the target state being interrogated (independent of s) and is only dependent on the type of sensing action taken. For the terminal classification action, defined by taking the action of declaring target u, we have

c(s,a=u)=Cᵤᵥ, ∀sεSᵥ (15)

The expected immediate cost of taking action a in belief state b(s) is

$$C ( b , a ) = {\sum }_{s} b ( s ) c ( s , a ) \qquad ( 16 )$$

For sensing actions, that have a cost independent to s, the expected cost is simply the known cost of performing the measurement. For the terminal classification action the expected cost is

$$C ( b , a = u ) = {\sum }_{v = 1}^{N} {\sum }_{s ∈ {S}_{v}} b ( s ) {C}_{uv} = {\sum }_{v = 1}^{N} {C}_{uv} p ( v \vert b ) \qquad ( 17 )$$

and therefore the optimal terminal action for a given belief state b is to choose that target u that minimizes the Bayes risk. The SMA provides an evaluation for policies that define when a belief state b warrants taking such a terminal classification action. When classification is not warranted, the desired policy defines what sensing actions should be executed for the associated belief state b.

The goal of a policy is to minimize the discounted infinite-horizon cost

$$χ ( b ) = {min}_{a} [ C ( b , a ) + γ {\sum }_{{b}^{′} ∈ B} p ( {b}^{′} \vert b , a ) χ ( {b}^{′} ) ] \qquad ( 18 )$$

where γε[0,1] is a discount factor that quantifies the degree to which future costs are discounted with respect to immediate costs, and B defines the set of all possible belief states. When optimized exactly for a finite number of iterations, the cost function is piece-wise linear and concave in the belief space.

After t consecutive iterations of (18) we have

$${χ}_{t} ( b ) = {min}_{a} [ C ( b , a ) + γ {\sum }_{{b}^{′} ∈ B} p ( {b}^{′} \vert b , a ) {χ}_{t - 1} ( {b}^{′} ) ] \qquad ( 19 )$$

where χₜ(b) represents the cost of taking the optimal action for belief state b at t steps from the horizon. One may show that χₜ(b)=min_{αεC}_{ₜ}Σ_{sεS}α(s)b(s), where the a vectors come from a set Cₜ={α₁, α₂, . . . , αᵣ)r}, where in general r is not known a priori and is a function of t. Each α vector defines an |S|-dimensional hyperplane, and each is associated with an action, defining the best immediate policy assuming optimal behavior for the following t−1 steps. The cost at iteration t may be computed by “backing up” one step from the solution t−1 steps from the horizon. Recalling that χₜ₋₁(b)=min_{αεC}_{_{i−1}}Σ_{sεS}α(s)b(s), we have

$${χ}_{t} ( b ) = {min}_{a ∈ A} [ C ( b , a ) + γ {\sum }_{o ∈ O} {min}_{α ∈ {C}_{t - 1}} {\sum }_{s ∈ S} {\sum }_{{s}^{′} ∈ S} p ( {s}^{′} \vert s , a ) p ( o \vert {s}^{′} , a ) α ( {s}^{′} ) b ( s ) ] \qquad ( 20 )$$

where A represents the set of possible actions (both for sensing and making classifications), and O represents the set of possible observations. When presenting results, the set of actions is discretized, as are the observations, such that both constitute a finite set.

The iterative solution of (20) corresponds to sequential updating of the set of α vectors, via a sequence of backup steps away from the horizon. In the preferred embodiment the SMA uses the state-of-the-art point-based value iteration (PBVI) algorithm, which has demonstrated excellent policy design on complex benchmark problems.

The sensing process is a sequence of questions asked by the sensor of the unknown target, with the physics providing the question answers. Specifically, the sensor asks: “For this unknown target, what would the data look like if the following measurement was performed?” To obtain the answer to this question the sensor performs the associated measurement. The sensor recognizes that the ultimate objective is to perform classification, and that a cost is assigned to each question. The objective is to ask the fewest number of sensing questions, with the goal of minimizing the ultimate cost of the classification decision (accounting for the costs of inaccurate classifications).

A reset formulation gives the sensor more flexibility in optimally asking questions and performing classifications within a cost budget. Specifically, the sensor may discern that a given classification problem is very “hard”. For example, prior to sensing it may be known that the object under test is one of N targets, and after a sequence of measurements the sensor may have winnowed this down to two possible targets. However, discerning between these final two targets may be a significant challenge, requiring many sensing actions. Once the complexity of the “problem” is understood, the optimal thing to do within this formulation is to stop asking questions and give the best classification answer possible, moving on to the next (randomly selected) classification problem, with the hope that it is “easier”. While the sensor may not do as well in classifying the “hard” classification problems, overall this action by the inventive system may reduce costs.

By contrast, if the sensor transitions into an absorbing state after performing classification, it cannot “opt out” of a “hard” sensing problem, with the hope of being given an “easier” problem subsequently. Therefore, with the absorbing-state formulation the sensor will on average perform more sensing actions, with the goal of reducing costs on the ultimate classification task.

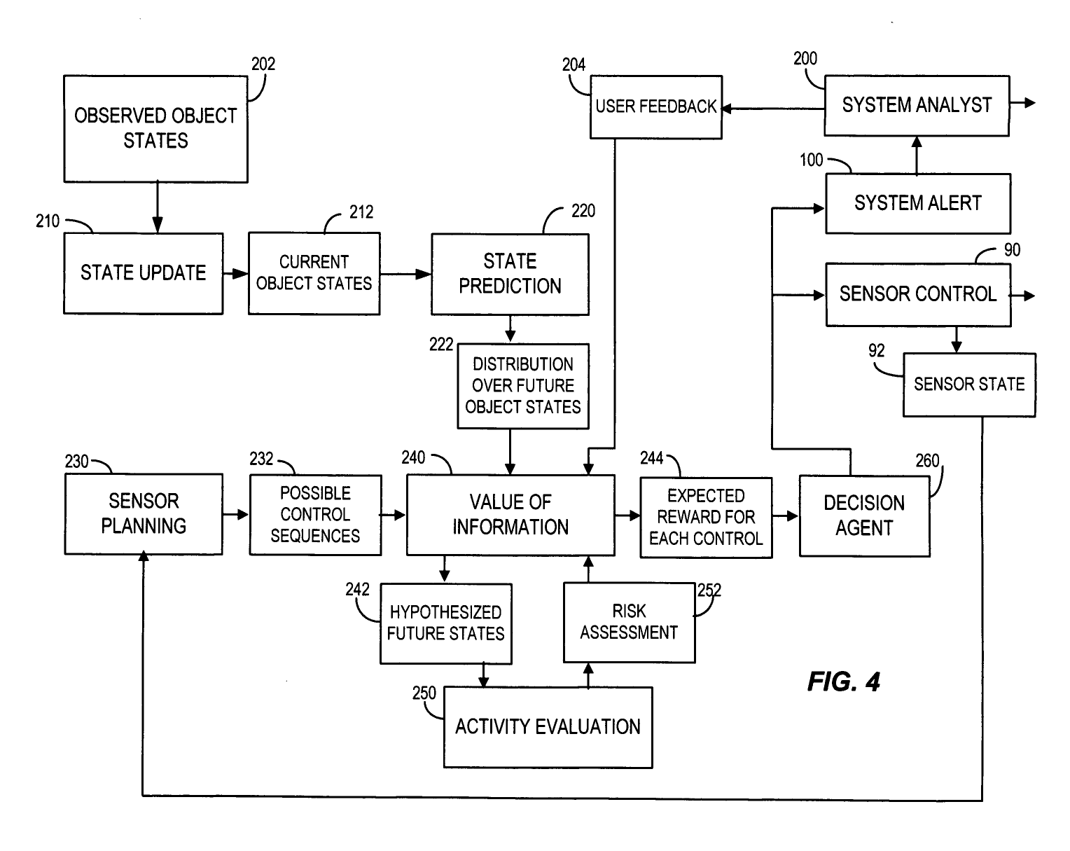

The most significant challenge in the inventive system is developing a policy that allows the ISR system to recognize that it is observing atypical behavior. This challenge is met by the Activity Evaluation module (FIG. 4). The Activity Evaluation module (FIG. 4) observes and recognizes atypical behavior to determine whether the scene under test corresponds to target Tₙₒₙₑ, where Tₙₒₙₑ represents that the data are representative of none of the typical target classes observed previously, in order to compare captured data against baseline data.

In the preferred embodiment, the system designates N graphical target models, for N hierarchical classes learned based on observing typical behavior. The algorithm may, after a sequence of measurements, take the action to declare the target under test as being any one of the N targets. In addition, the system may introduce a “none-of-the-above” target class, Tₙₒₙₑ, and allow the sensor-management agent to take the action of declaring Tₙₒₙₑ for the observed data. By utilizing the costs Cᵤᵥ, employed with Bayes risk, the inventive system can severely penalize errors in classifying data within the N classes. In this manner the SMA 70 will develop a policy that recognizes that it is preferable to declare Tₙₒₙₑ vis-à-vis making a forced decision to one of the N targets, when it is not certain.

Another function of the SMA 70 is to incorporate information from a human analyst in the loop of the policy decision process to provide reinforcement learning (RL) to the system. The framework outlined above consists of a two-step process: (i) data are observed and clustered, followed by graphical-model design for the hierarchical clusters; (ii) followed by policy design as implemented by (9) and (10). Once the policy is designed, a given sensing action is defined by a mapping from the belief state b to the associated action a. In this formulation the belief state is a sufficient statistic, and after N sensing actions retaining b determines the optimal N+1 action, rather than the entire history of actions and observations {a₁, a₂, . . . , a_{N}, o₁, o₂, . . . , o_{N}}.

The disadvantage of this approach is the need to learn the graphical models. Reinforcement learning (RL) is a model-free policy-design framework. Rather than computing a belief state, in the absence of a model, RL defines a policy that maps a sequence of actions and observations {a₁, a₂, . . . , a_{N}, o₁, o₂, . . . , o_{N}} to an associated optimal action. During the policy-learning phase, the algorithm assumes access to a sequence of actions, observations, and associated immediate rewards: {a₁, a₂, . . . , a_{N}, o₁, o₂, . . . , o_{N}, r₁, r₂, . . . , r_{N}}, where rₙ is the immediate reward for action and observation aₙ and oₙ. The algorithm again learns a non-myopic policy that maps {a₁, a₂, . . . , a_{N}, o₁, o₂, . . . , o_{N}} to an associated action a_{N+1}, but this is performed by utilizing the immediate rewards rₙ observed during the training phase. Reinforcement learning is a mature technology for Markov decision processes (MDPs), but it is not fully developed for POMDPs. The SMA 70 develops and uses an RL framework, and compares its utility to model-based POMDP design to produce the optimum algorithm for policy-learning. In the policy-learning phase the immediate rewards rₙ are defined by the cost of the associated actions aₙ and on whether the target under test is typical or atypical 340. The integration of the analyst within multi-sensor policy design is manifested most naturally within the RL framework.

The instant invention has developed effective methods for dynamic object ID and tracking in the context of controlled video scenes within the preferred embodiment. The inventive system has also demonstrated tracking and feature extraction for initial video datasets of complex outdoor scenery with moving vehicles, foliage, and clouds and in the presence of occlusions under rigorous test conditions.

In the preferred embodiment, the system has successfully applied object ID, tracking and feature analysis to non-overlapping training and testing data. To produce initial results, the system utilized data with multiple individuals exhibiting multiple types of behavior, but within the context of the same background scene. This training methodology is consistent with the envisioned SMA 70 concept, where each sensor will learn and adapt to various types of behavior typical to the scene that it is interrogating. For each object that is being tracked, the system extracts multiple feature sets corresponding to the temporal video sequence of that object while it is in view of the camera. FIG. 6 illustrates the pseudo-periodic nature of the feature sequence for a walking subject. The solid line near the top of the graph is indicative of “energy” associated with the subject's head, while the oscillations near the bottom of the graph indicate leg motion.

While feature analysis of existing video data has been performed in Matlab, the inventors are confident that real-time conversion of single objects within a frame to discrete HMM codebook elements is easily accomplished on current-generation DSP development boards. This is not surprising since after performing the PCA analysis in the training phase, the projection of the extracted features onto the PCA dictionary is simply a linear operation, which can be implemented very efficiently even in conventional hardware.

The preferred embodiment also applies the precepts for the system to the use of HMMs in extracting feature sequences from captured video data. Subsequent to feature extraction, PCA analysis and projection of the features onto their appropriate VQ codes, the system trained HMMs according to three different behavior types: walking, falling, and bending. Since the features for each of these behavior types are well-behaved and exhibit consistent clustering in the PCA feature subspace, the system uses a relatively small discrete HMM codebook size of eight vectors, one of which represented a “null code”. Features not representative of behavior observed in the training process were mapped into this null code, which exhibited the smallest, but non-zero likelihood of being observed within any particular HMM state. There was significant statistical separation between normal and anomalous behavior for over one thousand video sequences under test, thereby successfully demonstrating proof-of-concept for detection of this behavior.

The inventive system to be deployed is a portable, modular, reconfigurable and adaptive multi-sensor system for addressing any asymmetric threat. The inventive system will initially develop and test all algorithms in Matlab and will subsequently perform DSP system-level testing via Simulink. The first-generation prototypes will exist on DSP development boards, with a Texas Instrument floating-point DSP chip family similar to that used in commercially available systems. The preferred embodiment will require some additional video development into which the inventive system will integrate real-time DSP algorithms.

However, the inventive system is not limited to captured audio and video data and can allow integration of other sensors of potential interest to many industry segments including, but not limited to, radar, IP, and hyperspectral sensor suites. The inventive system is portable, modular, and reconfigurable in the field. These features allow the inventive system to be deployed in the field, provide a development path for future integration of new sensor modalities, and provide for the repositioning and integration of a sensor suite to meet particular missions for clients in the field.

The system will initially collect data of typical/normal behavior for the scene under test, and the data will then be clustered via the hierarchical clustering algorithm within the Tracking module 170 of the inventive system. This process employs feature extraction and graphical models embedded within the system database. Finally, these models will be employed to build POMDP and RL policies for optimal multi-sensor control, for the particular configuration in use.

The inventive system is also adaptive to new environments and conditions via the POMDP and RL algorithms within the SMA 70, yielding a policy for the optimal multi-sensor action for the data captured. The optimal policy will be non-myopic, accounting for sensing costs and the Bayes risk associated with making classification decisions.

In addition to expanding the number of sensors that may be deployed in the preferred embodiment which uses captured audio and video sensor data, some of the new components are the adaptive signal processing and sensor-management algorithms for more general sensor configurations. Specifically, by employing adaptive sensor control, the system may operate over significantly longer periods with the current storage capabilities, since the sensor will adaptively collect multi-sensor data at a resolution commensurate with the scene under interrogation (vis-à-vis having to preset the system resolution, as done currently). In addition, rather than fixing the manner in which the sensors collect data, the proposed system will perform multi-sensor adaptive data collections, with the adaptivity controlled via the POMDP/RL policy.

While this invention has been particularly shown and described with reference to preferred embodiments thereof, it will be understood by those skilled in the art that various changes in form and details may be made therein without departing from the spirit and scope of the invention as defined by the appended claims.

The shape model describes captured data values as objects when any group of pixels within the captured data moves as a group. This effectively groups together pixels which maintain a strong spatial dependence over time, keeping the definition as an object as the group of pixel data is tracked. The primary purpose of the shape model is to capture this spatial dependency between pixels corresponding to the same object. A novel method of modeling for representing these spatial dependencies has been developed, using a dynamic type of stochastic occupancy grid. This provides persistence for an object, once defined as such, that allows the object to separated from all other captured data and tracked in real time.

The trajectory model classifies objects within a captured data set to provide a directional representation for captured data objects. This produces an ability to track object position and velocity throughout the data set, producing a full probability distribution for identified objects within the captured dataset.

The color, shape, and trajectory models are combined into a unified group to provide an accurate measure of the position and motion of observed objects within the captured dataset. This translates into real world identification of objects, and tracking of objects in real time, as well as providing a predictive forecast for future positioning of identified objects. In addition, because a history of the captured data is retained for each of the model types, if a predicted position turns out to be in error when a new data capture from the sensor suite is processed, the tracking system may review the history of the color, shape, and trajectory models for each object and re-acquire any lost objects. This capability reduces dropped or lost objects and provides for more robust tracking capability for all identified objects.

While certain illustrative embodiments have been described, it is evident that many alternatives, modifications, permutations and variations will become apparent to those skilled in the art in light of the description.

We claim:

1. a method of capturing and processing sensor data to track data objects embedded within the sensor data and maintain an accessible active history of the data objects comprising:
receiving sensor measurement data from a suite of sensors deployed in the field;
processing the sensor measurement data to locate data objects of interest and create shape, color and trajectory models for each data object;
storing the data object models in an active memory storage device and simultaneously displaying the most current data object model information to a user;
wherein each iteration of stored data object model information creates a history from which a data object model may be reconstructed or from which an entire sensor measurement data set may be recovered and displayed if sensor data or a data object model is no longer available.

2. a method as in claim 1 of capturing and processing sensor data to track data objects embedded within the sensor data and maintain an accessible active history of the data objects comprising, wherein said deployed sensors may be sensors that collect video, audio, radar, infrared, ultrasonic, or hyper-spectral data, or any combination of said sensor types.

3. a method as in claim 1 of capturing and processing sensor data to track data objects embedded within the sensor data and maintain an accessible active history of the data objects comprising, wherein each data object is represented by a different likelihood of possibility for each color, shape and trajectory model and the probabilities are stored with each model within the database.

4. a method as in claim 3 of capturing and processing sensor data to track data objects embedded within the sensor data and maintain an accessible active history of the data objects comprising, wherein the color, shape, and trajectory models are combined into a unified group to provide an accurate measure of the position and motion of data objects within the sensor data.

5. a method as in claim 4 of capturing and processing sensor data to track data objects embedded within the sensor data and maintain an accessible active history of the data objects comprising, wherein the unified group of model data is presented on a display device as tracking data to a user.

6. a method as in claim 1 of capturing and processing sensor data to track data objects embedded within the sensor data and maintain an accessible active history of the data objects comprising, wherein multiple copies of sensor data and object model data are maintained within the active database.

7. a method as in claim 6 of capturing and processing sensor data to track data objects embedded within the sensor data and maintain an accessible active history of the data objects comprising, wherein when a data object is lost from an incoming sensor measurement data set, the data object history may be retrieved from the previously stored data object and thereupon used to reconstitute the data object within the current tracking display.

8. a method as in claim 6 of capturing and processing sensor data to track data objects embedded within the sensor data and maintain an accessible active history of the data objects comprising, wherein when a sensor measurement data set is lost for any reason the sensor measurement data set may be reconstituted from the stored history data for the sensor measurement data set.

9. a computer program product within a storage device for capturing and processing sensor data to track data objects embedded within the sensor data and maintain an accessible active history of the data objects comprising:
receiving sensor measurement data from a suite of sensors deployed in the field;
processing the sensor measurement data to locate data objects of interest and create shape, color and trajectory models for each data object;
storing the data object models in an active memory storage device and simultaneously displaying the most current data object model information to a user;
wherein each iteration of stored data object model information creates a history from which a data object model may be reconstructed or from which an entire sensor measurement data set may be recovered and displayed if sensor data or a data object model is no longer available.

10. a computer program product within a storage device as in claim 9 for capturing and processing sensor data to track data objects embedded within the sensor data and maintain an accessible active history of the data objects comprising, wherein said deployed sensors may be sensors that collect video, audio, radar, infrared, ultrasonic, or hyper-spectral data, or any combination of said sensor types.

11. a computer program product within a storage device as in claim 9 for capturing and processing sensor data to track data objects embedded within the sensor data and maintain an accessible active history of the data objects comprising, wherein each data object is represented by a different likelihood of possibility for each color, shape and trajectory model and the probabilities are stored with each model within the database.

12. a computer program product within a storage device as in claim 11 for capturing and processing sensor data to track data objects embedded within the sensor data and maintain an accessible active history of the data objects comprising, wherein the color, shape, and trajectory models are combined into a unified group to provide an accurate measure of the position and motion of data objects within the sensor data.

13. a computer program product within a storage device as in claim 12 for capturing and processing sensor data to track data objects embedded within the sensor data and maintain an accessible active history of the data objects comprising, wherein the unified group of model data is presented on a display device as tracking data to a user.

14. a computer program product within a storage device as in claim 9 for capturing and processing sensor data to track data objects embedded within the sensor data and maintain an accessible active history of the data objects comprising, wherein multiple copies of sensor data and object model data are maintained within the active database.

15. a computer program product within a storage device as in claim 14 for capturing and processing sensor data to track data objects embedded within the sensor data and maintain an accessible active history of the data objects comprising, wherein when a data object is lost from an incoming sensor measurement data set, the data object history may be retrieved from the previously stored data object and thereupon used to reconstitute the data object within the current tracking display.

16. a computer program product within a storage device as in claim 14 for capturing and processing sensor data to track data objects embedded within the sensor data and maintain an accessible active history of the data objects comprising, wherein when a sensor measurement data set is lost for any reason the sensor measurement data set may be reconstituted from the stored history data for the sensor measurement data set.
